(19) United States
(12) Patent Application Publication
(10) Pub. No.: US 2011/0221186 A1
(43) Pub. Date: Sep. 15, 2011

(54) CONNECTION MECHANISMS

(76) Inventor: James Lu, Fremont, CA (US)

(21) Appl. No.: 12/723,488

(22) Filed: Mar. 12, 2010

(51) Int. Cl. F16L 27/00; H01R 11/00

(52) U.S. Cl. 285/272; 439/502

(57) ABSTRACT

A joint connector including a first member which includes a first passageway structure and a first groove structure. The joint connector may also include a second member coupled with the first member, wherein the second member includes a second passageway structure and second groove structure, and wherein the second passageway structure may be connected to the first passageway structure. The joint connector may also include a coupling component coupling the first member with the second member. A first portion of the coupling component may be disposed inside the first groove structure. A second portion of the coupling component may be disposed inside the second groove structure. The first portion of the coupling component may at least partially surround the second portion of the coupling component.

### BACKGROUND OF THE INVENTION

The present invention is related to connection mechanisms. For example, the invention may be related to joint connectors which include swiveling parts. Connection mechanisms, such as joint connectors, may be found in various applications. For example, a joint connector may be employed for connecting a pneumatic tool to an air hose. As another example, a joint connector may be utilized for connecting a hydraulic tool to a water hose. A swiveling part of a joint connector may enable the tool to swivel with respect to the hose, thereby providing additional flexibility and maneuverability when the tool is used in performing various tasks.

In general, a joint connector may include a first member for connecting to the tool and a second member for connecting to the hose. The joint connector may also include at least one screw for coupling the first member with the second member in a way that the first member and the second member may swivel with respect to each other. Typically, the screw as well as the threads (disposed in the first member and/or in the second member) mating with the screw may need to satisfy strict precision requirements. If the coupling between the screw and the threads is too loose, fluid (e.g., air, water, or oil) leakage may occur, resulting in waste of energy and resource, and even contamination. On the other hand, if the coupling between the screw and the threads is too tight, the first member and the second member may not be able to properly swivel with respect to each other. The strict precision requirements on the screw and the threads may substantially increase the cost of the joint connector.

### SUMMARY

An embodiment of the present invention is related to a joint connector. The joint connector may include a first member which includes a first passageway structure and a first groove structure. The joint connector may also include a second member coupled with the first member, wherein the second member includes a second passageway structure and second groove structure, and wherein the second passageway structure may be connected to the first passageway structure. The joint connector may also include a coupling component coupling the first member with the second member. A first portion of the coupling component may be disposed inside the first groove structure. A second portion of the coupling component may be disposed inside the second groove structure. The first portion of the coupling component may at least partially surround the second portion of the coupling component.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A shows a schematic representation illustrating a perspective view of a connection mechanism in accordance with one or more embodiments of the present invention.

FIG. 1B shows a schematic representation illustrating a cross-sectional view of a connection mechanism in accordance with one or more embodiments of the present invention.

FIG. 1C shows a schematic representation illustrating a cross sectional view of a member of a connection mechanism in accordance with one or more embodiments of the present invention.

FIG. 1D shows a schematic representation illustrating a top view of a coupling component of a connection mechanism in an uncompressed state in accordance with one or more embodiments of the present invention.

FIG. 1E shows a schematic representation illustrating a top view of a coupling component of a connection mechanism in a compressed state in accordance with one or more embodiments of the present invention.

FIG. 2A shows a schematic representation illustrating a top view of a coupling component of a connection mechanism in an uncompressed state in accordance with one or more embodiments of the present invention.

FIG. 2B shows a schematic representation illustrating a top view of a coupling component of a connection mechanism in a compressed state in accordance with one or more embodiments of the present invention.

FIG. 3 shows a flowchart illustrating a method for assembling a connection mechanism in accordance with one or more embodiments of the present invention.

FIG. 4 shows a schematic representation illustrating a cross-sectional view of a connection mechanism in accordance with one or more embodiments of the present invention.

FIG. 5 shows a schematic representation illustrating a cross-sectional view of a connection mechanism in accordance with one or more embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

One or more embodiments of the invention are related to a connection mechanism, such as a joint connector. The connection mechanism may be utilized in, for example, connecting a fluid-driven tool with a fluid hose, connecting a mechanical part with another mechanical part, and/or connecting an electrical part with another electrical part. The connection mechanism may include a first member which includes a first passageway structure and a first groove structure. The connection mechanism may also include a second member coupled with the first member, wherein the second member includes a second passageway structure and second groove structure, and wherein the second passageway structure may be connected to the first passageway structure to form a continuous passageway.

The connection mechanism may also include a coupling component for coupling the first member with the second member by engaging both the first groove structure and the second groove structure, with a first portion of the coupling component being disposed inside the first groove structure, and with a second portion of the coupling component being disposed inside the second groove structure. Engaging both the groove structures, the coupling component may securely couple the first member with the second member, preventing the first member and the second member from being separated. At the same time, the coupling component may allow the first member and the second member to swivel relative to each other.

The use of the coupling component may eliminate the need for a screw in coupling the two members of the connection mechanism. As a result, precision requirements associated with the use of a screw may be eliminated. Advantageously, manufacturing and maintenance costs associated with the connection mechanism may be minimized, and/or the quality and reliability of the connection mechanism may be economically provided.

One or more embodiments of the invention are related to a method for assembling a connection mechanism, such as the connection mechanism with the coupling component discussed above. The method may include compressing the coupling component such that the outer diameter of the coupling component is smaller than the diameter of a coupling portion of the first passageway of the first member. The method may also include inserting the combination of the compressed coupling component and a protrusion of the second member into a coupling portion of the first passageway of the first member, wherein the protrusion of the second member may include the second groove structure, wherein at least the second portion of the compressed coupling component may be predisposed inside the second groove structure, and wherein the coupling portion may include the first groove structure. After the insertion, the coupling component may expand (to the uncompressed state or a less compressed state of the coupling component) such that the first portion of the coupling component is disposed into the first groove structure. After the expansion, the coupling component may engage both the first groove structure and the second groove structure, thereby securely coupling the first member with the second member.

In comparison with methods for assembling a prior art connection mechanism using a screw, embodiments of the invention may eliminate the need for aligning a screw driver with the screw and the need for turning the screw with a suitable torque. Advantageously, the method may simplify the assembly process in manufacturing connection mechanisms, thereby improving the efficiency of manufacturing the connection mechanisms. The method may also advantageously reduce or prevent errors in manufacturing connection mechanisms, thereby ensuring the quality of the connection mechanisms.

The features and advantages of the present invention may be better understood with reference to the figures and discussions that follow.

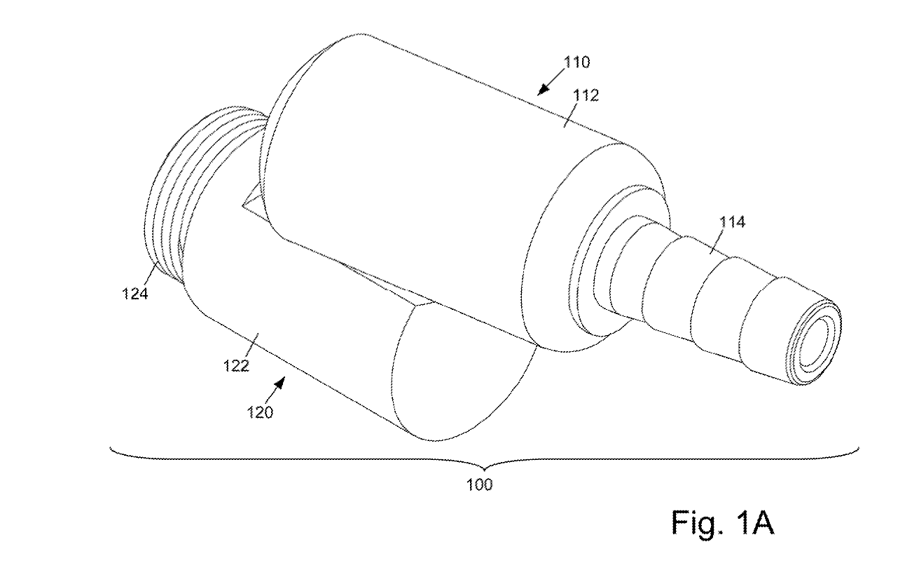

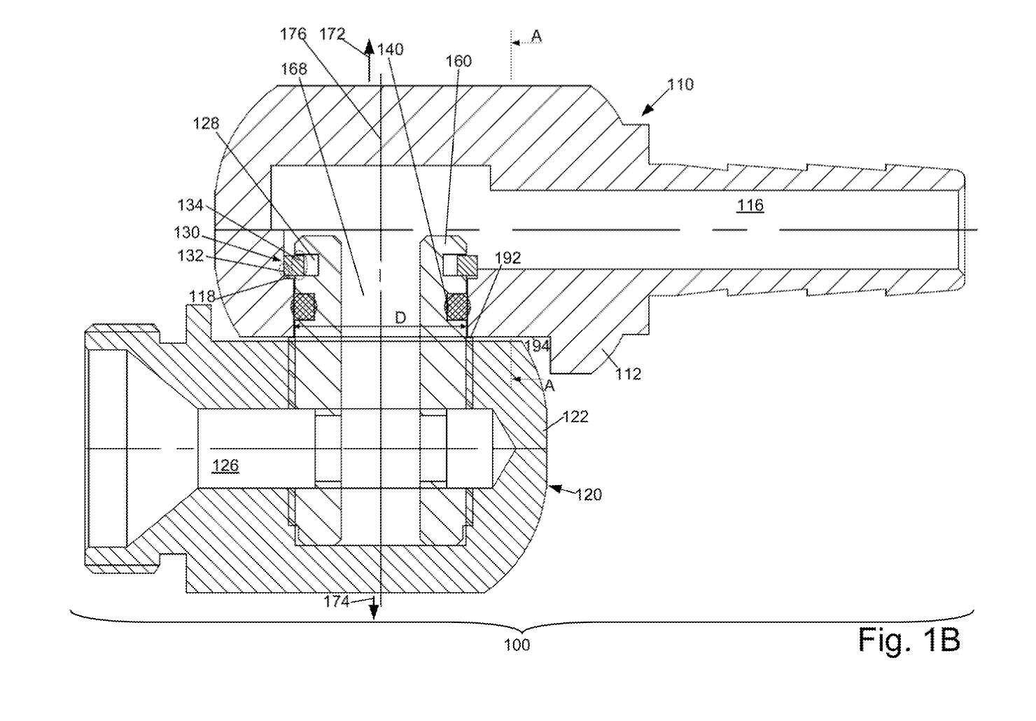

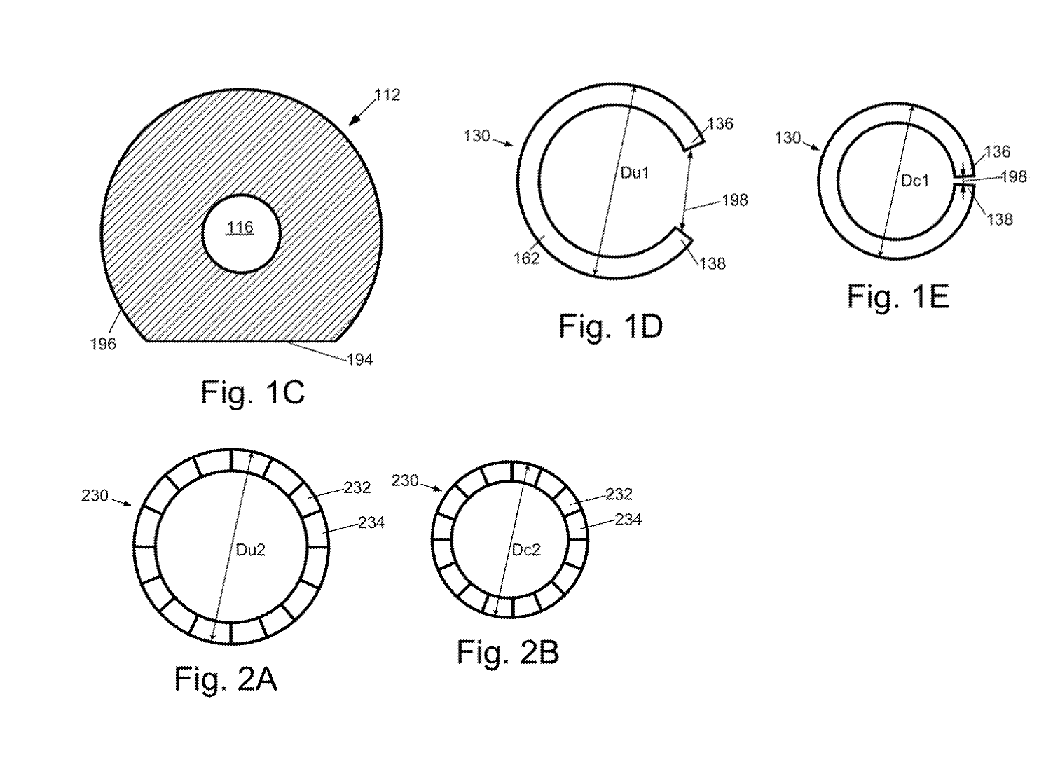

FIG. 1A shows a schematic representation illustrating a perspective view of a connection mechanism 100 in accordance with one or more embodiments of the present invention. For example, connection mechanism 100 may represent a joint connector for use in, for example, connecting a fluid-driven tool with a fluid hose, connecting a mechanical part with another mechanical part, and/or connecting an electrical part with another electrical part.

As illustrated in the example of FIG. 1A, connection mechanism 100 may include a first member 110 and a second member 120. First member 110 may include a body 112 and a connecting head 114, wherein connecting head 114 may be mechanically coupled with and/or integrated with body 112. Second member 120 may include a body 122 and a connecting head 124, wherein connecting head 124 may be mechanically coupled with and/or integrated with body 122. In one or more example applications of connection mechanisms 100, connecting head 114 may be coupled with a fluid-driven tool (e.g., a pneumatic tool, a hydraulic tool, or a sprinkler), and connecting head 124 may be coupled with a fluid-transmitting hose. In one or more example applications of connection mechanism 100, connecting head 114 may be coupled with an automobile door, and connecting head 124 may be coupled with an automobile body. The components of connection mechanism 100 may be made of one or more materials well known in the art, such as plastic, aluminum, copper, iron, steel, and/or stainless steel.

Body 112 may be coupled with body 122 in a way that first member 110 and second member 120 may swivel with respect to each other. The mechanism for coupling body 112 with body 122 is further discussed in the example of FIG. 1B.

FIG. 1B shows a schematic representation illustrating a cross-sectional view of connection mechanism 100 in accordance with one or more embodiments of the present invention. As illustrated in the example of FIG. 1B, first member 110 may include a passageway structure 116 for accommodating a fluid flow and/or for accommodating electrical connection between devices connected by connection mechanism 100; second member 120 may include a passageway structure 126, connected to passageway structure 116, for accommodating the fluid flow and/or for accommodating the electrical connection.

In addition to first member 110 and second member 120, connection mechanism 100 may also include a coupling component 130 for coupling first member 110 with second member 120. Coupling component 130 may cooperate with at least a groove structure 118 of first member 110 and a groove structure 128 disposed at a protrusion 160 of second member 120 to secure protrusion 160 of second member 120 inside a coupling portion 168 of passageway structure 116 of first member 110. Passageway structure 126 may extend through protrusion 160 to connect to passageway structure 116.

As illustrated in the example of FIG. 1B, coupling component 130 may at least partially surround at least a portion of groove structure 128, and groove structure 118 may at least partially surround coupling component 130. In addition, a first portion 132 (or outer portion) of coupling component 130 may be disposed inside groove structure 118, and a second portion 134 (or inner portion) of coupling component 130 may be disposed inside groove structure 128, wherein first portion 132 may at least partially surround second portion 134. Accordingly, a top portion of groove structure 128 and a bottom portion of groove structure 118 may secure (or clamp) coupling component 130 between the top portion of groove structure 128 and the bottom portion of groove structure 118. In turn, by engaging both the bottom portion of groove structure 118 and the top portion of groove structure 128, coupling structure 130 may limit the movement of first member 110 in a breakaway direction 172 with respect to second member 120, and coupling structure 130 may limit the movement of second member 120 in a breakaway direction 174 with respect first member 110. Therefore, coupling component may effectively, securely couple first member 110 with second member 120, preventing first member 110 and second member 120 from breaking off from each other.

At the same time, coupling component 130 may permit first member 110 to swivel or rotate about (an axis 176 of) protrusion 160 of second member 120. By engaging at least one of groove structure 118 and groove structure 128, coupling component may also guide the swiveling movement of first member 110 and/or second member 120. The friction, feature(s), and/or shape(s) of the contact surface(s) of coupling component 130, groove structure 118, and/or groove structure 128 may be properly tuned to optimize the relative swiveling movement of first member 110 and second member 120 and/or to provide desirable tactile feedback to the user of connection mechanism 100. Tuning the friction, feature(s), and/or shape(s) of the contact surface(s) may be performed by, for example, selecting coupling component 130 from a plurality of coupling components.

Also for facilitating the swiveling movement of first member 110 and/or second member 120. Each of first member 110 and second member 120 may include a flat portion to provide a sufficient clearance between first member 110 and second member 120, as illustrated by cross section A-A of body 112 of first member 110 shown in the example of FIG. 1C. Second member 120 may also include a support portion 192 (protruding from body 122) for supporting and guiding a flat bottom portion 194 of body 112 of first member 110 during the swiveling movement, wherein flat bottom portion 194 may contact support portion 192.

In one or more embodiments, coupling component 130 may alternatively or additionally engage one or more other portions of first member 110 and/or second member 120, for optimizing the coupling between first member 110 and second member 120, and/or for optimizing the swiveling operation of first member 110 and/or second member 120. For example, coupling component 130 may engage an inner wall of coupling portion 168 with optimized friction and contact surface features to provide desirable tactile feedback to the user of connection mechanism 100.

Connection mechanism 100 may also include an o-ring 140 disposed between protrusion 160 of second member 120 and body 112 of first member 110. O-ring 140 may prevent fluid leakage at a gap between protrusion 160 and body 112. O-ring 140 may be disposed between coupling component 130 and body 122 of second member 120 (instead of being disposed above coupling component 130), in order to avoid hindering the insertion of the combination of coupling member 130 and protrusion 160 into coupling portion 168. Additionally or alternatively, one or more o-rings may be disposed between passageway structure 116 and coupling member 130, for preventing coupling member 130 from being exposed to the fluid transmitted through passageway structure 116.

Also for facilitating the insertion of the combination of coupling member 130 and protrusion 160 into coupling portion 168, coupling component 130 may need to be compressed to make the outer diameter of coupling component 130 smaller than the diameter D of coupling portion 168. The compression of coupling component 130 is further discussed with reference to the examples of FIGS. 1D and 1E.

FIG. 1C shows a schematic representation illustrating a cross sectional view A-A (indicated in the example of FIG. 1B) of body 112 of first member 110 of connection mechanism 100 in accordance with one or more embodiments of the present invention. As illustrated in the example of FIG. 1C, the perimeter of the cross section of body 112 includes flat bottom portion 194 and a partial circular portion 196. Flat bottom portion 194 may provides a sufficient clearance from second member 120 and may provide a contact surface for facilitating/guiding swiveling movement of first member 110 and/or second member 120. Partial circular portion 196 and at least a portion of passageway structure 116 may be substantially concentric for facilitating the manufacturing of body 112.

In one or more embodiments, body 112 may have a non-circular cross section for satisfying particular requirements. For example, body 112 may have a substantially square or substantially rectangular cross section for satisfying storage requirements.

FIG. 1D shows a schematic representation illustrating a top view of coupling component 130 of connection mechanism 100 (illustrated in the example of FIGS. 1A and 1B) in an uncompressed state in accordance with one or more embodiments of the present invention. Coupling component 130 may be a resilient, compressible C-shaped component made of, for example, steel or stainless steel. Coupling component 130 may include a partial circular portion 162 having a first end 136 and a second end 138, with a gap 198 existing between first end 136 and second end 138. Partial circular portion 162 may be at least half of a circle, for providing sufficient contact surfaces for engaging portions of groove structure 118 and groove structure 128 (illustrated in the example of FIG. 1B). Gap 198 may enable coupling component 130 to be compressed to reduce the outer diameter of coupling component 130, for inserting the combination of coupling component 130 and protrusion 160 of second member 120 (illustrated in the example of FIG. 1B) into coupling portion 168 of first member 110 (illustrated in the example of FIG. 1B). Coupling component 130 in a compressed state is illustrated in the example of FIG. 1E.

FIG. 1E shows a schematic representation illustrating a top view of coupling component 130 in a compressed state in accordance with one or more embodiments of the present invention. As illustrated in the example of FIG. 1E, coupling component 130 may be compressed with first end 136 and second end 138 being brought closer to each other and with the size of gap 198 being reduced. As illustrated in the examples of FIGS. 1D-1E, the outer diameter of coupling component 130 may be reduced from Du1 to Dc1, smaller than the diameter D of coupling portion 168 of first member 110 (illustrated in the example of FIG. 1B), for enabling the combination of coupling component 130 and protrusion 160 of second member 120 (illustrated in the example of FIG. 1B) to be inserted into coupling portion 168 of first member 110.

After the insertion, coupling component 130 may expand to a less compressed state or to the uncompressed state to engage both groove structure 118 and groove structure 128, thereby securely and rotatably coupling first member 110 with second member 120.

FIG. 2A shows a schematic representation illustrating a top view of a coupling component 230 of a connection mechanism in an uncompressed state in accordance with one or more embodiments of the present invention. Coupling component 230 may be employed as a part of connection mechanism 100 in place of coupling component 130 discussed above. In one or more embodiments, a suitable coupling component may be selected from a set of coupling components, e.g., including coupling component 130 and coupling component 230, for perform the aforementioned contact surface tuning.

Coupling component 230 may have a circular shape (or ring shape) and may include a resilient, compressible structure. For example, coupling component 230 may include one or more spring sections, such as spring section 232 and spring section 234. Coupling component may be compressed for reducing the outer diameter of coupling component 230 for facilitating the insertion of the combination of coupling component 230 and protrusion 160 of second member 120 (illustrated in the example of FIG. 1B) into coupling portion 168 of first member 110 (illustrated in the example of FIG. 1B).

FIG. 2B shows a schematic representation illustrating a top view of coupling component 230 in a compressed state in accordance with one or more embodiments of the present invention. As illustrated in the examples of FIGS. 2A-2B, coupling component 230 may be compressed such that the outer diameter of coupling component 230 may be reduced from Du2 to Dc2, smaller than the diameter D of coupling portion 168 of first member 110 (illustrated in the example of FIG. 1B), for enabling the combination of coupling component 230 and protrusion 160 of second member 120 (illustrated in the example of FIG. 1B) to be inserted into coupling portion 168 of first member 110.

After the insertion, coupling component 230 may expand to at least partially resume the outer diameter of coupling component 230, to Du2 or to a value between Du2 and Dc2 if limited by groove structure 118, to engage both groove structure 118 and groove structure 128, thereby securely and rotatably coupling first member 110 with second member 120.

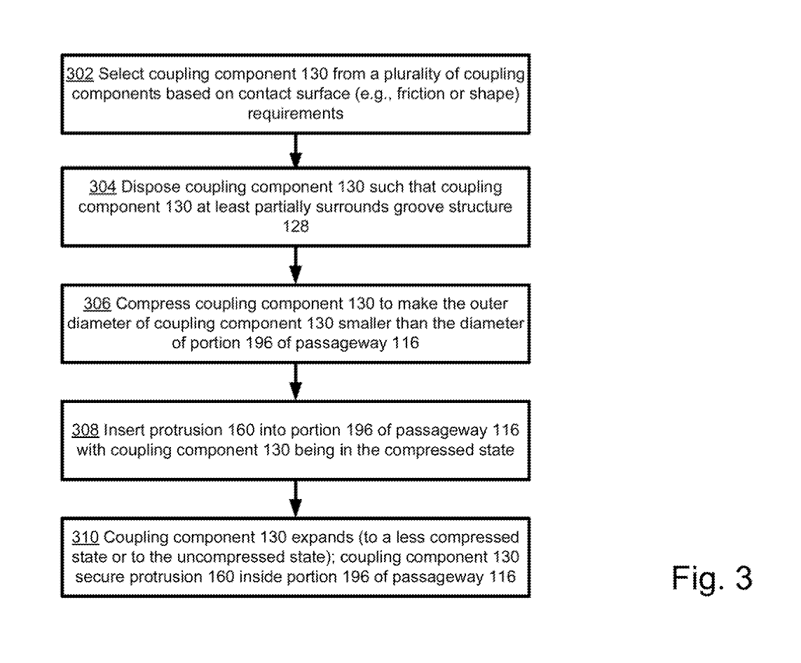

FIG. 3 shows a flowchart illustrating a method for assembling a connection mechanism, such as connection mechanism 100 illustrated in the examples of FIGS. 1A and 1B, in accordance with one or more embodiments of the present invention. The method may start with step 302, a human operator and/or an automatic manufacturing system (e.g., a system including a robotic operator) may select a suitable coupling component from a plurality of coupling components based on a set of contact surface (e.g., friction, feature, or shape) requirements related to the interface between the selected coupling component and at least one groove structure of connection mechanism 100 configured to be engaged by the selected coupling component. The contact surface requirements may be related to performance requirements and/or application requirements (e.g., the smoothness, path, and/or tactile feedback of swiveling movement) of connection mechanism 100. For example, the selected coupling component may be coupling component 130 illustrated in the examples of FIGS. 1B, 1D, and 1E.

In step 304, the operator and/or the automatic manufacturing system may dispose coupling component 130 such that coupling component 130 at least partially surrounds groove structure 128 located at protrusion 160 (illustrated in the example of FIG. 1B), with at least portion 134 being disposed inside groove structure 128.

In step 306, utilizing a suitable tool, the operator and/or the automatic manufacturing system may compress coupling component 130 to make the outer diameter of coupling component 130 smaller than the diameter D of portion 196 of passageway 116 (illustrated in the example of FIG. 1B).

In step 308, with coupling component 130 being in the compressed state, the operator and/or the automatic manufacturing system may insert the combination of coupling component 130 and protrusion 160 into portion 196 of passageway 116.

In step 310, coupling component 130 may expand to a less compressed state or to the uncompressed state, for example, limited by groove structure 118 (illustrated in the example of FIG. 1B). As a result, as illustrated in the example of FIG. 1B, coupling component 130 may engage both groove structure 118 and groove structure 128 to secure protrusion 160 inside portion 196 of passageway 116, thereby securely (and rotatably) coupling second member 120 with first member 110.

As can be appreciated from the method discussed above, no screws are need for coupling second member 120 with first member 110. The method may eliminate the need for aligning a screw driver with a screw as well as the need for turning the screw with a suitable torque. Advantageously, the method may simplify the assembly process in manufacturing connection mechanism 130, thereby improving the efficiency of manufacturing connection mechanism 130; the method may also reduce or prevent errors in manufacturing connection mechanism 130, thereby ensuring the quality of connection mechanism 130.

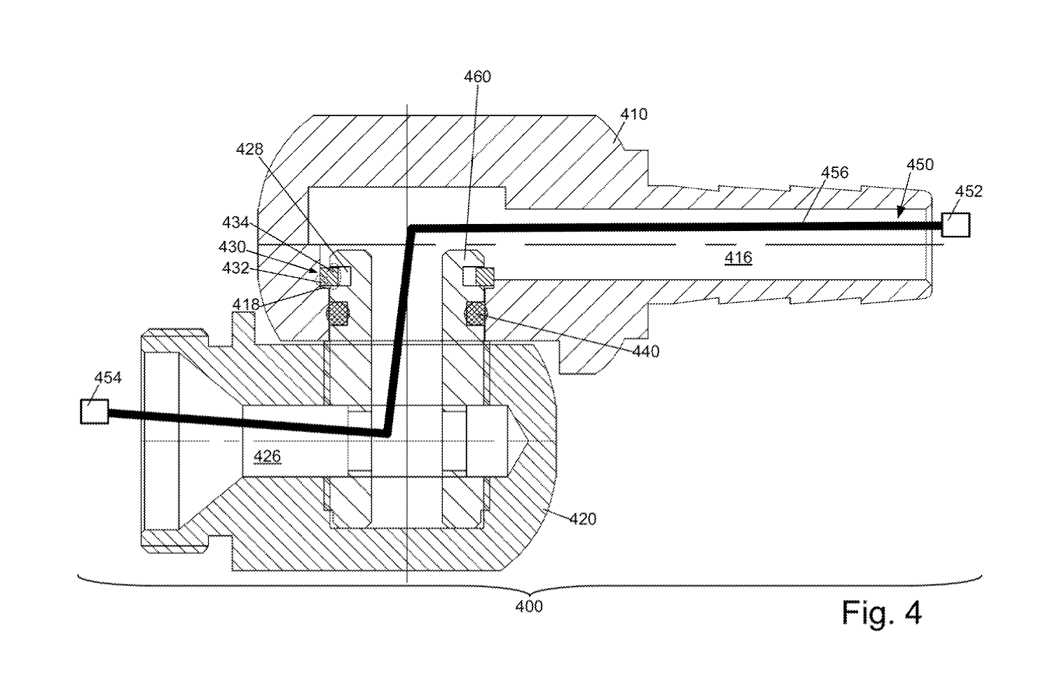

FIG. 4 shows a schematic representation illustrating a cross-sectional view of a connection mechanism 400 in accordance with one or more embodiments of the present invention. Connection mechanism 400 may include a plurality components, including a first member 410 (having a passageway structure 416 and a groove structure 418), a second member 420 (having a passageway structure 426 and a groove structure 428), a coupling component 430, an o-ring 440, etc., which may be similar to first member 110, second member 120, coupling member 130, and o-ring 140, etc. of connection mechanism 100 illustrated in one or more of the example of FIGS. 1A-1E. Coupling component 430 may engage both groove structure 418 and groove structure 428, with a first portion 432 of coupling component 430 being disposed inside groove structure 418 and with a second portion 434 being disposed inside groove structure 428. Accordingly, first member 410 may be securely (and rotatably) coupled with second member 420.

In addition, connection mechanism 400 may include an electrical connector 450. Electrical connector 450 may include a first conducting terminal 452, a second conducting terminal 454, and a set of conducting media 456 coupled between first conducting terminal 452 and second conducting terminal 454. The set of conducting media 456 may include one or more wires or cables. Each of first conducting terminal 452 and second conducting terminal 454 may include one or more conducting contacts for electrically coupling with at least an electrical and/or electronic device. In addition to providing mechanical connection with the flexibility of swiveling movement, connection mechanism 400 may also advantageously provide electrical connection with the flexibility of swiveling movement. For example, in one or more embodiments, connection mechanism 400 may mechanically and electrically couple an automobile door with an automobile body, wherein electrical connector 450 may transmit signals from a stereo system disposed in the automobile body to one or more speakers disposed at the automobile door. The signals may be reliably transmitted even when the automobile door swivels.

Electrical connector 450 (or at least the set of conducting media 456) may extend through and may be surrounded by at least passageway structure 416 and passageway structure 426. Electrical connector 450 may also extend through a protrusion 460 of second member 420, which is disposed inside passageway structure 416, wherein coupling component 430 may at least partially surround a portion of electrical connector 450. Electrical connector 450 may be protected by the surrounding components such that the reliability of electrical signal transmission may be ensured.

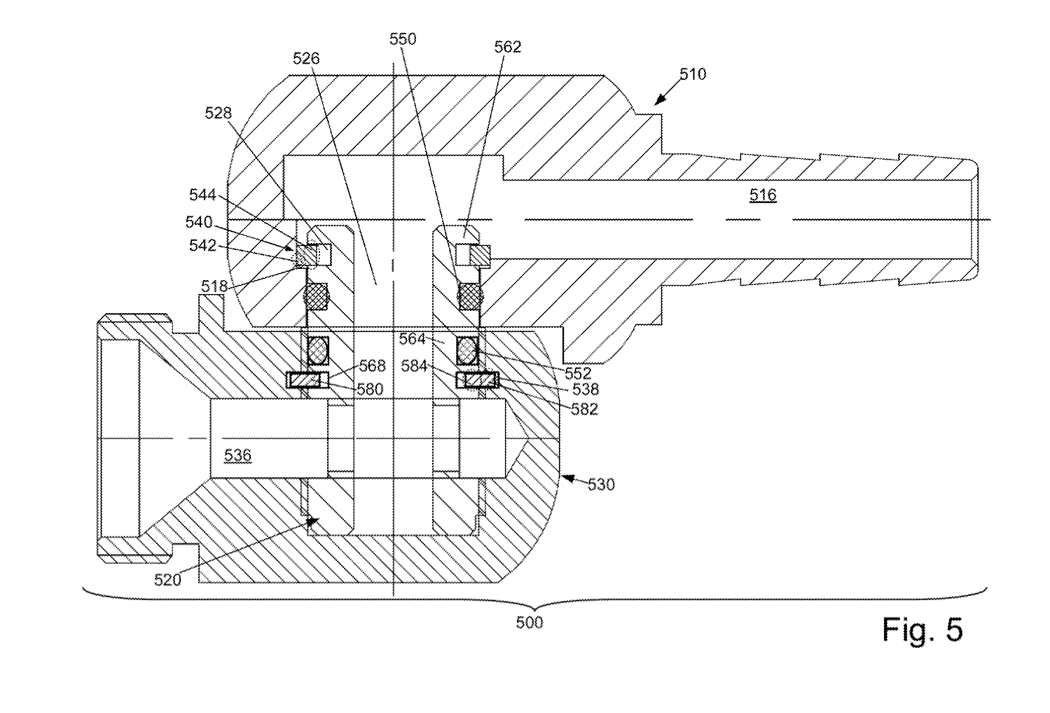

FIG. 5 shows a schematic representation illustrating a cross-sectional view of a connection mechanism 500 in accordance with one or more embodiments of the present invention. As illustrated in the example of FIG. 5, connection mechanism 500 may include a first member 510, a second member 520, and a third member 530, wherein first member 510 may be mechanically coupled with third member 530 through second member 520.

Each of first member 510, second member 520, and third member 530 may include one or more passageway structures for facilitating fluid flow and/or for facilitating electrical connection through the members. For example, first member 510, second member 520, and third member 530 may include a passageway structure 516, a passageway structure 526, and a passageway structure 536, respectively. Passageway structure 516 may connect to passageway structure 536 through passageway structure 526 to form a continuous, end-to-end passageway extending from the connecting head of first member 510 to the connecting head of third member 530. In one or more embodiments, connection mechanism 500 may include an electrical connector, e.g., similar to electrical connector 450 illustrated in the example of FIG. 4, extending through the continuous passageway formed by passageway structure 516, passageway structure 526, and passageway structure 536, for providing electrical connectivity.

Connection mechanism 500 may also include one or more coupling components cooperating with one or more groove structures of first member 510, second member 520, and/or third member 530 to facilitate the mechanical coupling between the members. For example, connection mechanism 500 may include a coupling member 540 engaging both a groove structure 518 of first member 510 and a groove structure 528 of second member 520, with a first portion 542 of coupling member 540 being disposed inside groove structure 518 and with a second portion 544 of coupling member 540 being disposed inside groove structure 528, to securely (and rotatably) couple first member 510 with second member 520. No screws are needed for coupling first member 510 with second member 520. As another example, connection mechanism 500 may include a coupling member 580 engaging both a groove structure 538 of third member 530 and a groove structure 568 of second member 520, with a first portion 582 of coupling member 580 being disposed inside groove structure 538 and with a second portion 584 of coupling member 580 being disposed inside groove structure 568, to securely (and rotatably) couple third member 530 with second member 520. No screws are needed for coupling third member 530 with second member 520.

Each of coupling component 540 and coupling component 580 may be similar to coupling component 130 and/or coupling component 230 discussed above with reference to one of more of examples of FIGS. 1B, 1D, 1E, 2A, and 2B, including at least a resilient, compressible portion and/or a gapped structure, for facilitating the insertion of the combination of coupling component 540 and a first portion 562 of second member 520 into first member 510, or for facilitating the insertion of the combination of coupling member 580 and a second portion 564 of second member 530 into third member 530. After the combination of coupling component 540 and first portion 562 of second member 520 has been inserted into first member 510, coupling component 540 may expand to simultaneously engage both groove structure 518 and groove structure 528, thereby securely (and rotatably) coupling first member 510 with second member 520. Similarly, after the combination of coupling component 580 and second portion 564 of second member 520 has been inserted into third member 530, coupling component 580 may expand to simultaneously engage both groove structure 538 and groove structure 568, thereby securely (and rotatably) coupling third member 510 with second member 520. The method for coupling first member 510 with second member 520 and the method for coupling third member 510 with second member 520 may be similar to the method for assembling connection mechanism 100 discussed with reference to the example of FIG. 3.

Connection mechanism 500 may also include one or more sealing components for preventing fluid leakage. For example, connection mechanism 500 may include an o-ring 550 for sealing a gap between first member 510 and first portion 562 of second member 520. Additionally or alternatively, connection mechanism 500 may include an o-ring 552 for sealing a gap between third member 530 and second portion 564 of second member 520. O-ring 550 and/or o-ring 552 may be disposed between coupling component 540 and coupling component 580, in order to avoid hindering the insertion of the combination of coupling member 540 and first portion 562 of second member 520 into first member 510, and/or in order to avoid hindering the insertion of the combination of coupling member 580 and second portion 564 of second member 520 into third member 530. In one or more embodiments, one or more o-rings may be disposed between a coupling component and a passageway structure to prevent the coupling component from being exposed to the fluid transmitted through the passageway structure.

As can be appreciated from the foregoing, embodiments of the invention may eliminate the need for screws and threads in manufacturing connection mechanisms with swiveling movement capability, such as joint connectors. As a result, precision requirements associated with screws and threads may be eliminated. Advantageously, manufacturing and maintenance costs associated with the connection mechanisms may be minimized, and/or the quality and reliability of the connection mechanisms may be economically provided.

Eliminating the need for screws and threads in manufacturing connection mechanisms, embodiments of the invention may also simplify the assembly process in manufacturing connection mechanisms. Advantageously, embodiments of the invention may improve the efficiency of manufacturing the connection mechanisms; embodiments of the invention may also reduce or prevent errors in manufacturing connection mechanisms, thereby ensuring the quality of the connection mechanisms.

While this invention has been described in terms of several embodiments, there are alterations, permutations, and equivalents, which fall within the scope of this invention. It should also be noted that there are many alternative ways of implementing the methods and apparatuses of the present invention. Furthermore, embodiments of the present invention may find utility in other applications. The abstract section may be provided herein for convenience and, due to word count limitation, may be accordingly written for reading convenience and should not be employed to limit the scope of the claims. It may be therefore intended that the following appended claims be interpreted as including all such alternations, permutations, and equivalents as fall within the true spirit and scope of the present invention.

What is claimed is:

1. A joint connector comprising:
a first member including a first passageway structure and a first groove structure;
a second member coupled with the first member, the second member including a second passageway structure and second groove structure, the second passageway structure being connected to the first passageway structure; and
a first coupling component coupling the first member with the second member, a first portion of the first coupling component being disposed inside the first groove structure, a second portion of the first coupling component being disposed inside the second groove structure, the first portion of the first coupling component at least partially surrounding the second portion of the first coupling component.

2. The joint connector of claim 1 wherein
the first coupling component is a C-shaped component,
a gap exists between a first end of the C-shaped component and a second end of the C-shaped component, and
the shape of the C-shaped component is at least one half of a circle shape.

3. The joint connector of claim 1 wherein
the first coupling component at least partially surrounds at least a portion of the second groove structure, and
the first groove structure surrounds the first coupling component.

5. The joint connector of claim 1 wherein a top portion of the second groove structure and a bottom portion of the first groove structure secure the first coupling component between the top portion of the second groove structure and the bottom portion of the first groove structure.

6. The joint connector of claim 1 wherein
the second member includes a protrusion,
the protrusion includes the second groove structure, and
the protrusion is disposed inside the first passageway structure.

7. The joint connector of claim 6 wherein the second passageway structure extends through the protrusion.

8. The joint connector of claim 1 further comprising:
a third member including a third passageway structure and a third groove structure, the third passageway structure being connected to the second passageway structure; and
a second coupling component coupling the third member with the second member,
wherein the second member further includes a fourth groove structure,
a first portion of the second coupling component is disposed inside the third groove structure,
a second portion of the second coupling component is disposed inside the fourth groove structure,
a first portion of the second member is disposed inside the first passageway structure, and
a second portion of the second member is disposed inside the third passageway structure.

9. The joint connector of claim 8 wherein
the second coupling component is a C-shaped component made of metal,
a gap exists between a first end of the C-shaped component and a second end of the C-shaped component, and
the shape of the C-shaped component is at least one half of a circle.

10. The joint connector of claim 8 wherein
the second coupling component at least partially surrounds at least a portion of the fourth groove structure, and
the third groove structure surrounds the second coupling component.

11. The joint connector of claim 1 wherein a perimeter of a cross-section of the first member includes a partial circular portion and a flat portion.

12. A connection mechanism comprising:
a first member including a first passageway structure and a first groove structure;
a second member coupled with the first member, the second member including a second passageway structure and second groove structure, the second passageway structure being connected to the first passageway structure;
a first coupling component coupling the first member with the second member, a first portion of the first coupling component being disposed inside the first groove structure, a second portion of the first coupling component being disposed inside the second groove structure, the first portion of the first coupling component at least partially surrounding the second portion of the first coupling component; and
an electrical connector extending through at least the first passageway structure and the second passageway structure, wherein the first coupling component at least partially surrounds a first portion of the electrical connector.

13. The connection mechanism of claim 12 wherein
the first coupling component is a C-shaped component,
a gap exists between a first end of the C-shaped component and a second end of the C-shaped component, and
the shape of the C-shaped component is at least one half of a circle.

14. The connection mechanism of claim 12 wherein
the first coupling component at least partially surrounds at least a portion of the second groove structure, and
the first groove structure surrounds the first coupling component.

15. The connection mechanism of claim 12 wherein a top portion of the second groove structure and a bottom portion of the first groove structure secure the first coupling component between the top portion of the second groove structure and the bottom portion of the first groove structure.

16. The connection mechanism of claim 12 wherein a top portion of the second groove structure and a bottom portion of the first groove structure secure the first coupling component between the top portion of the second groove structure and the bottom portion of the first groove structure.

17. The connection mechanism of claim 12 wherein
the second member includes a protrusion,
the protrusion includes the second groove structure, and
the protrusion is disposed inside the first passageway structure.

18. The connection mechanism of claim B7 wherein the second passageway structure extends through the protrusion.

19. The connection mechanism of claim 12 further comprising:
a third member including a third passageway structure and a third groove structure, the third passageway structure being connected to the second passageway structure; and
a second coupling component coupling the third member with the second member,
wherein the second member further includes a fourth groove structure,
a first portion of the second coupling component is disposed inside the third groove structure,
a second portion of the second coupling component is disposed inside the fourth groove structure,
a first portion of the second member is disposed inside the first passageway structure,
a second portion of the second member is disposed inside the third passageway structure,
the electrical connector further extends through the third passageway structure, and
the second coupling component at least partially surround a second portion of the electrical connector.

20. The connection mechanism of claim 19 wherein
the second coupling component is a C-shaped component made of metal,
a gap exists between a first end of the C-shaped component and a second end of the C-shaped component,
the shape of the C-shaped component is at least one half of a circle,
the second coupling component at least partially surrounds at least a portion of the fourth groove structure, and
the third groove structure surrounds the second coupling component.
